(19) United States
(12) Patent Application Publication
(10) Pub. No.: US 2007/0106881 A1
(43) Pub. Date: May 10, 2007

(54) Bit-wise operation followed by byte-wise permutation for implementing DSP data manipulation instructions

(75) Inventor: Gregory M. Thornton, Portland, OR (US)

Correspondence Address: Richard Calderwood;Stexar Corp., 20400 NW Amberwood Dr. #100, Beaverton, OR, 97006-7099, US

(73) Assignee: Stexar Corp.

(21) Appl. No.: 11/270,213

(22) Filed: Nov. 8, 2005

(51) Int. Cl. G06F 9/44

(52) U.S. Cl. 712/223

(57) ABSTRACT

A digital signal processor having a generalized byte-wise data movement permute facility configurable at the microarchitectural level to execute a variety of ISA-level byte-wise data manipulation instructions. A bit-wise data manipulation facility is also provided. By combining the two, the bit-wise facility can be greatly simplified without sacrificing ISA-level functionality of bit-wise data manipulation instructions.

### BACKGROUND OF THE INVENTION

1. Technical Field of the Invention

This invention relates generally to programmable microprocessors, and more specifically to instructions for a digital signal processor which use bit-wise and byte-wise data movements to accomplish a variety of data manipulations.

2. Background Art

FIGS. 1-5 illustrate a 128-bit data location, such as a register, treated as storing a variety of data element sizes. In FIG. 1, the register holds sixteen bytes of eight bits each. In FIG. 2, the register holds eight words of sixteen bits each. In FIG. 3, the register holds four doublewords of thirty-two bits each. In FIG. 4, the register holds two quadwords of sixty-four bits each. In FIG. 5, the register holds one hundred twenty-eight single bits. Other data sizes are possible, such as a single octoword of one hundred twenty-eight bits, or thirty-two nibbles of four bits each, and so forth.

The data elements are conventionally addressed from 0 to N-1, where N is the number of data elements. Conventionally, bits within a byte are addressed 0-7 from the least significant bit to the most significant bit, and are shown ordered right to left. In the conventional little-endian data arrangement, the least significant byte within a multi-byte data element is stored at the lowest address and the most significant byte is stored at the highest address. In the less common big-endian data arrangement, the bytes within a multi-byte data element are stored in the opposite order; however, those skilled in the art know how to handle these differences, and the remainder of this disclosure will be in little-endian terms, for simplicity and consistency. In this disclosure, the data elements will be addressed as indicated by the hexadecimal digits shown above the register in the respective figure. The byte positions will be addressed as indicated by the hexadecimal digits shown in FIG. 1. Values shown within data elements are used to indicate the data values stored in those locations, and will typically represent eight-bit values shown in two-digit hexadecimal format 00 through FF.

Microprocessors, microcontrollers, digital signal processors, ASICs, and other programmable digital logic devices are commonly adapted to execute a variety of instruction types, such as addition, subtraction, multiplication, and so forth. One such type of operation is data movement instructions, such as shifts, rotates, and the like. Some data movement instructions are “bit-wise”, meaning that they are capable of moving data on single bit granularity, rather than e.g. byte granularity. Some data movement instructions are “byte-wise”, meaning that they move bytes around but keep the eight bits of any given byte intact, together, and in the same order, as the bytes are moved around. Other data movement instructions operate on larger data elements, such as words, doublewords, or quadwords, and move intact chunks of that size around without reordering the bits within any given chunk.

In general, the wider a shifter or rotator is made, the more complex its logic becomes, and the more time it takes to complete its operation.

Applicant has realized that, by combining byte-wise operations with bit-wise operations, many data manipulation operations can be simplified. Or, more precisely, the hardware required to perform them can be simplified. Additionally, Applicant has realized that a generalized byte-wise data manipulation operation can be used as a powerful, fundamental operation, to implement a wide variety of specific data movement operations upon a variety of element sizes.

### BRIEF DESCRIPTION OF THE DRAWINGS

FIGS. 1-5 show a 128-bit data element considered as 16 bytes, 8 words, 4 doublewords, 2 quadwords, and 128 bits, respectively.

FIG. 6 shows a digital signal processor including a byte permutation instruction execution unit for performing the instructions described above.

FIGS. 7-8 show a permute instruction operating upon byte data and word data, respectively.

FIG. 9 shows an explode instruction operating upon byte data.

FIG. 10 shows a merge instruction operating upon byte data.

FIG. 11 shows a pack instruction operating upon low bytes of word data.

FIG. 12 shows sign bit replication.

FIG. 13 shows an unpack sign extended instruction operating upon low bytes of word data.

FIGS. 14-18 show a shuffle pair instruction operating upon high bytes of word data across 16 partitions, 8 partitions, 4 partitions, 2 partitions, and 1 partition, respectively.

FIGS. 19-22 show a shuffle pair instruction operating upon low words of doubleword data across 8 partitions, 4 partitions, 2 partitions, and 1 partition, respectively.

FIGS. 23-24 show a shuffle pair instruction operating upon high doublewords of quadword data across 2 partitions and 1 partition, respectively.

FIG. 25 shows a shuffle pair instruction operating upon low quadwords across 2 partitions.

FIG. 26 shows a bit field selection instruction operating upon bit data.

FIG. 27 shows how a bit field selection instruction can be implemented using this invention.

FIGS. 28-30 show a rotate left instruction operating upon byte data, word data, and doubleword data, respectively.

FIG. 31 shows an alternate method of implementing a doubleword rotate left instruction.

FIG. 32 shows how a saturating (clipping) pack low instruction can be implemented.

FIG. 33 shows how a shift right signed word instruction can be implemented.

FIG. 34 shows how a shift right signed doubleword instruction can be implemented.

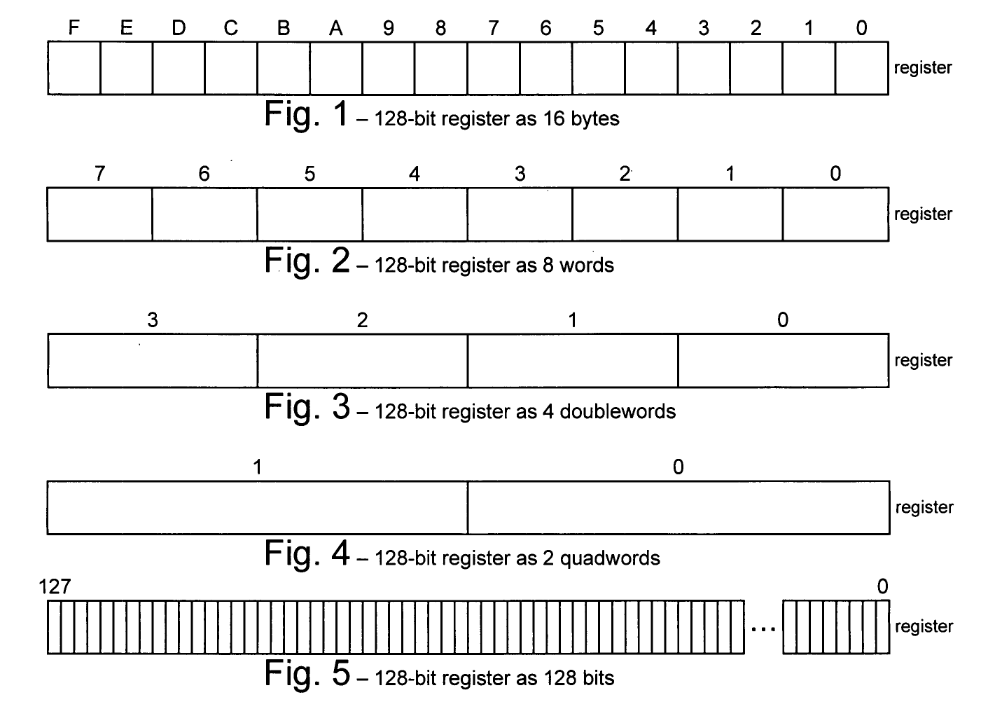

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

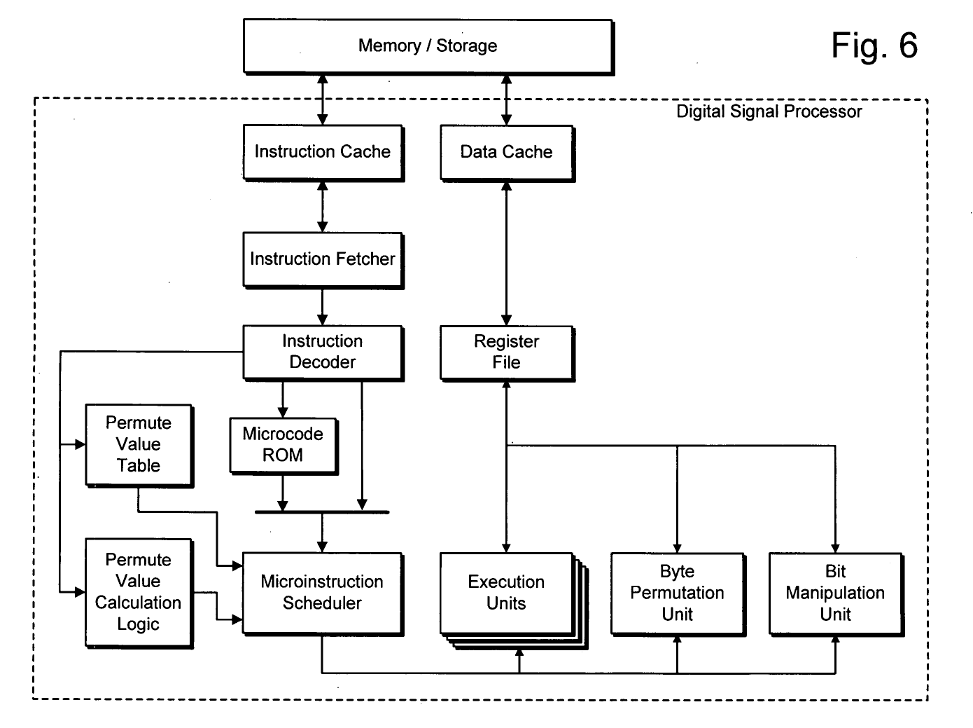

FIG. 6 illustrates a digital signal processor, microprocessor, or other form of programmable processor adapted for executing instructions. The processor includes an instruction cache and a data cache which are (typically via bus units, not shown) interfaced to an external memory/storage system. An instruction fetcher fetches instructions from the memory via the instruction cache. An instruction decoder decodes the fetched instructions into microinstructions (μops). Some instructions' pops are provided directly by the instruction decoder, and some—typically the lengthier, more complicated pop flows—are retrieved from a microcode ROM. A microinstruction scheduler receives the Lops and provides them, and their operand data, to one or more execution units when the appropriate execution units and operand data are available. The execution units write result data to destinations, typically in a register file.

A processor according to the present invention may, in one embodiment, include a dedicated byte permutation unit as one of the execution units. It may also include a dedicated bit manipulation unit. Alternatively, the byte permute functionality and/or bit manipulation functionality can be implemented within one or more of the other execution units.

The present invention is centered on two capabilities: the ability to perform byte-wise permute operations, and the ability to perform bit-wise data manipulation operations, and the processor's ability to use one or both of them in implementing a variety of instructions.

The processor may additionally include a permute value table which provides predefined control values for some byte-wise permute operations, and/or permute value calculation logic which generates e.g. operand-dependent control values for other byte-wise permute operations.

The reader should make continued reference to FIG. 6 while studying the rest of this disclosure.

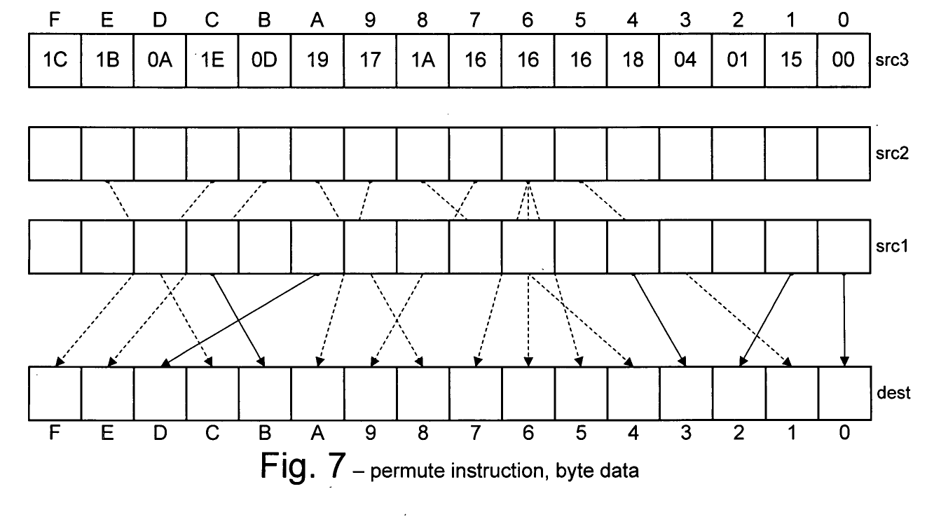

FIG. 7 illustrates the operation of a byte-wise permute instruction. The permute instruction has three input source operands src1, src2, and src3 and an output destination operand dest. Each byte src3[i] of the third source src3 specifies a location from which the corresponding byte dest[i] of the destination will be copied. The upper nibble of src3[i] is either a 0 or a 1, specifying src1 and src2, respectively. The lower nibble of src3[i] specifies which byte of that register will be copied into dest[i]. (The reader should note that the conventional terminology is somewhat unfortunate, in that a high src3[i] nibble of “1” specifies src2 rather than src1; this is because the source operands are conventionally numbered from src1 rather than from src0.) In the example shown, src3[0] contains the hexadecimal value 00, causing src1[0] to be copied to dest[0]; src3[1] contains the hexadecimal value 15, causing src2[1] to be copie dest[1]; and so forth. In this disclosure, dashed lines will be used to show data flow from src2 to dest, and solid lines will be used to show data flow from src1 to dest, to help the reader correctly trace the arrows in the drawings. The dashed lines from src2 to dest traverse behind src1 in the drawings.

Other processors, such as the Altivec processor from IBM, Motorola, and Apple, have had such a byte-wise permute instruction in their instruction set architecture (ISA). Applicant is not the originator of this instruction nor its functionality. Applicant believes he is, however, the first to recognize that it may be used, alone or in combination with bit-wise operations, to implement a wide variety of other data manipulation instructions on a variety of data element sizes.

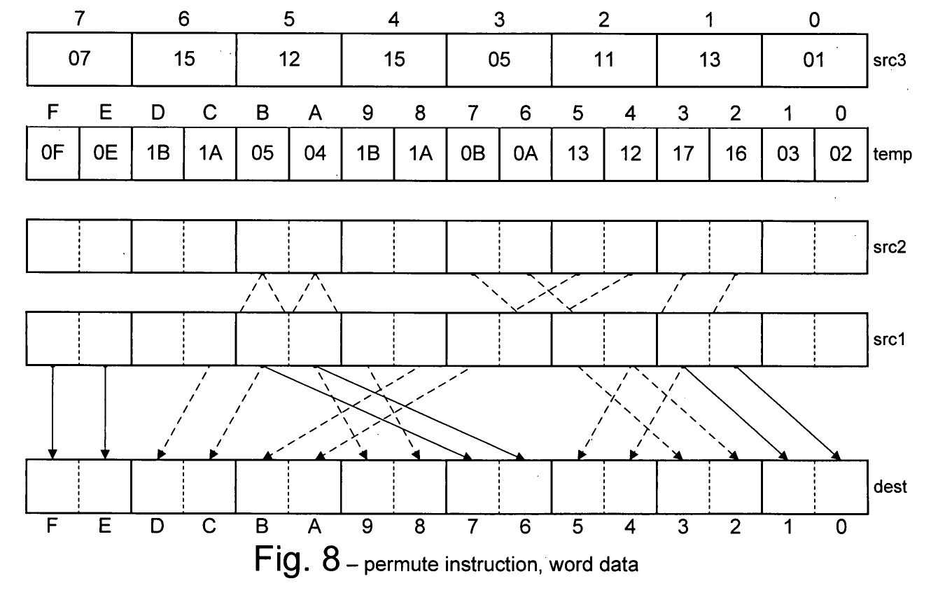

FIG. 8 illustrates the use of the byte-wise permute facility for implementing a word-wise permute instruction—perhaps the simplest expansion of the power of the byte-wise permute. The word-wise permute instruction specifies first and second source operands src1 and src2 from which word data elements are to be selected for copying into the destination dest. The instruction also has a control source operand src3 in which word sized data elements specify respective words of src1 and src2. Typically, but not necessarily, the high-order bytes of each of the control word operands in src3 will simply contain the hex value 00.

In the example shown, src3[0] contains the hexadecimal value 01, specifying that dest[word 0] should be loaded with src1[word 1], or, in other words, that dest[1:0] should be loaded with src1[3:2]. In one implementation, the processor generates a temporary control word temp from src3. The value 01 in src3[word 0] specifies src1[word 1], so the processor loads temp[1] with the hex value 03 and temp[0] with the hex value 02. The remaining bytes of temp are loaded appropriately. In one embodiment, the instruction decoder determines that the instruction's opcode specifies a word-wise permute, and the permute value calculation logic generates the values in temp according to the values in src3.

The permute value generation logic which generates temp from src3 for this instruction can be represented as follows (although it would typically be implemented as parallel circuitry rather than any sort of looping software).

| for i:= 0; i<15; i+=2 | |
|---|---|
| { | temp[i] := ((src3[i]&0F)<<1) \|\| (src3[i]&10); |
| | temp[i+1] := temp[i]+1; } |

With temp appropriately loaded with byte-wise permute values, the processor can simply execute the byte-wise permute instruction's operation, using temp instead of src3 as its control source.

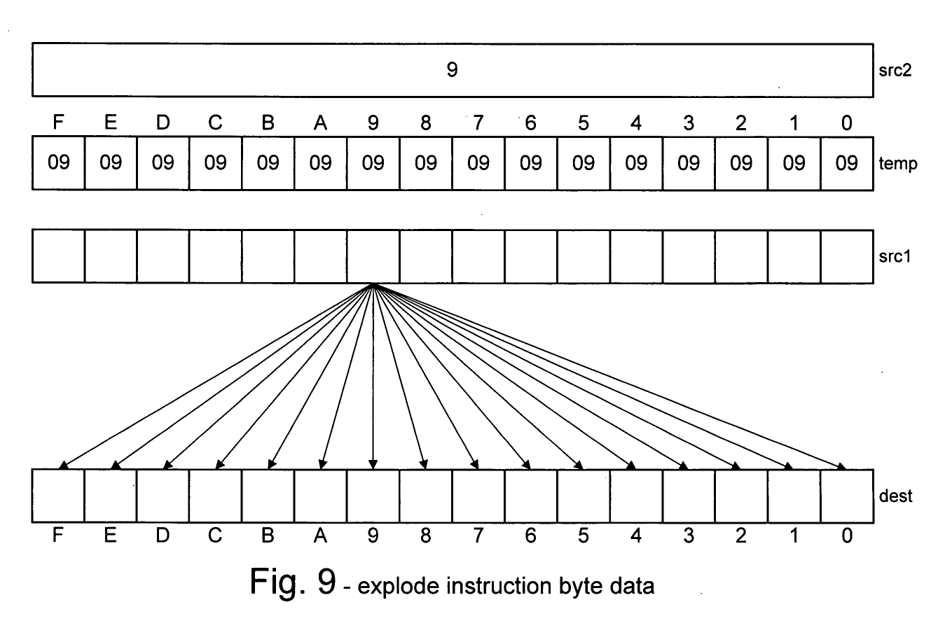

FIG. 9 illustrates the use of the byte-wise permute facility for implementing a byte-wise explode instruction. The instruction specifies a source operand src1, and provides a control operand src2 containing a single value which indicates which single byte of src1 should be copied into all byte positions of dest.

The processor implements this functionality using the permute facility. The value from src2 (typically in src2[0]) is copied into each element temp[i]. In one implementation, the facility 5 relies on the programmer to have loaded a valid (less than hexadecimal 10) value into src2. In another implementation, the processor forces each temp[i] value to be valid by performing
for i:=0; i<15; i++temp[i]:=src2[0]&0F

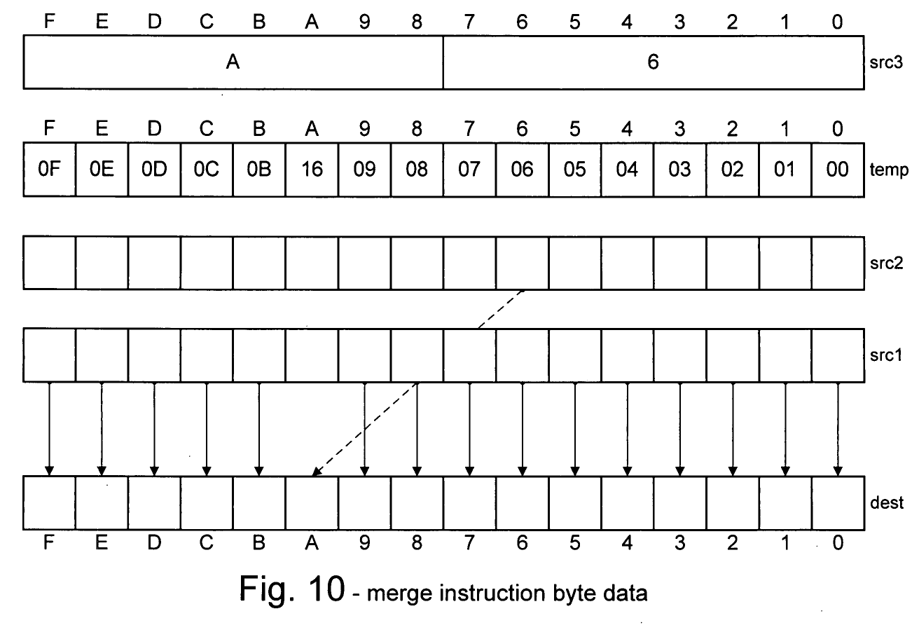

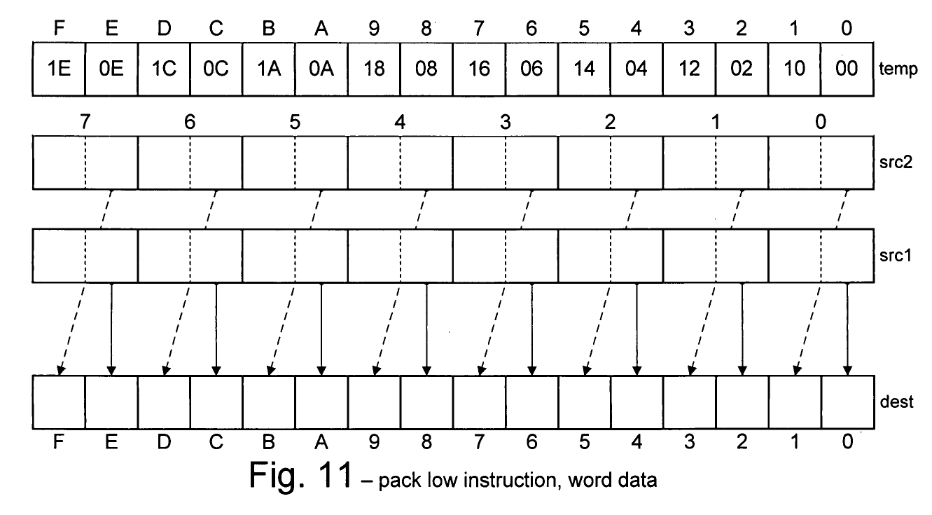

The processor then executes the byte-wise permute operation, and the specified byte of src1 is copied into each byte of dest. FIG. 10 illustrates the use of the byte-wise permute facility for implementing a byte merge instruction. The instruction specifies two source operands src1 and src2. A third operand src3 contains two control values. In one embodiment, as shown, the control values are located in the low-order bytes of the two quadwords of src3. In another embodiment, they may be in any other predetermined locations, such as src3[0] and src3[1]. The function of the merge instruction is to copy all of src1 into dest, except that a single byte from a specified location in src2 is copied into a single byte of dest at a possibly different specified location. In one embodiment, the low-order quadword of src3 specifies the byte src3[i] to be copied, and the high-order quadword of src3 specifies the location dest[j] into which it is to be written.

The processor implements this functionality using the permute facility. The bytes of a temporary control register, temp[0] through temp[F] are loaded with the values 00 through 0F, except the byte temp[0X] is loaded with the value 1Y, where X is the low-order nibble from the high-order quadword of src3 and Y is the low-order nibble of the low-order quadword of src3.

The processor then simply executes the permute operation, using temp instead of src3 as the control register.

FIG. 11 illustrates the use of the byte-wise permute facility for implementing a word-wise pack low instruction. The instruction specifies two source operands src1 and src2, and a destination dest. This operation copies the low-order bytes out of the words in src1 into the even-numbered byte positions in src3, and copies the low-order bytes out of the words in src2 into the odd-numbered byte positions in src3, interlacing them as shown.

The processor implements this functionality by loading a temporary control register temp with the values shown. The values have the following pattern. Each pair, from the low-order pair to the high-order pair, gets a next even value in its bytes' low-order nibbles. Each even-numbered byte gets a 0 in its high-order nibble, and each odd-numbered byte gets a 1 in its high-order nibble. When the processor then executes the byte-wise permute operation using temp as the control source, this picks the low-order (even-numbered) bytes alternately from src1, src2, src1, src2, and so on.

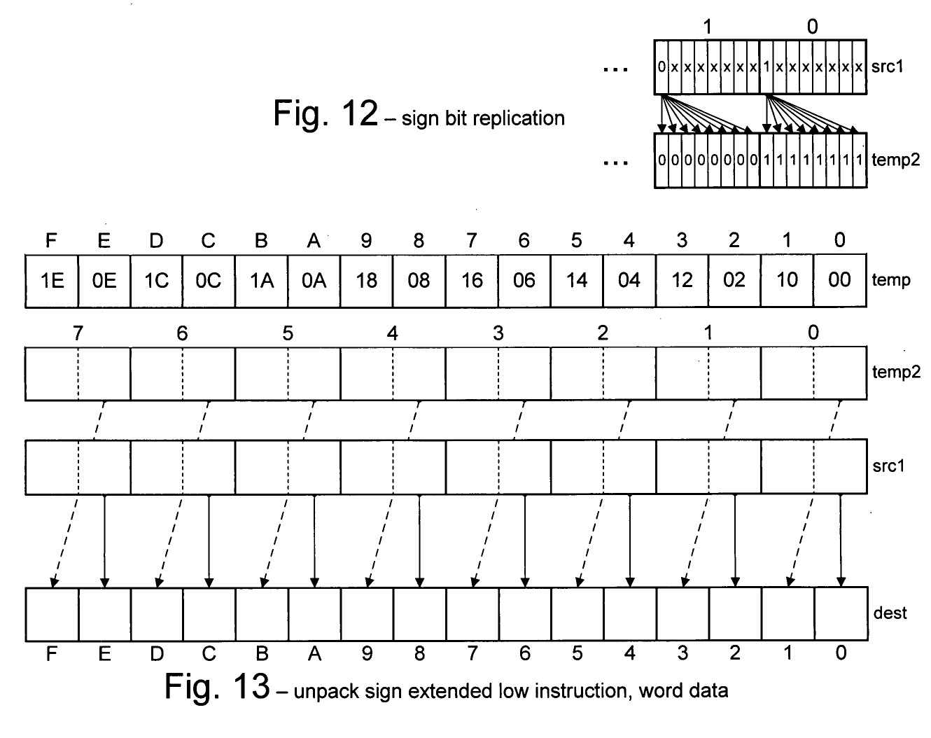

FIG. 12 illustrates sign bit replication which occurs when the processor replicates the sign bits from src1 into a temporary register temp2, preparatory to performing certain operations. The sign bit is the high-order bit of a signed byte.

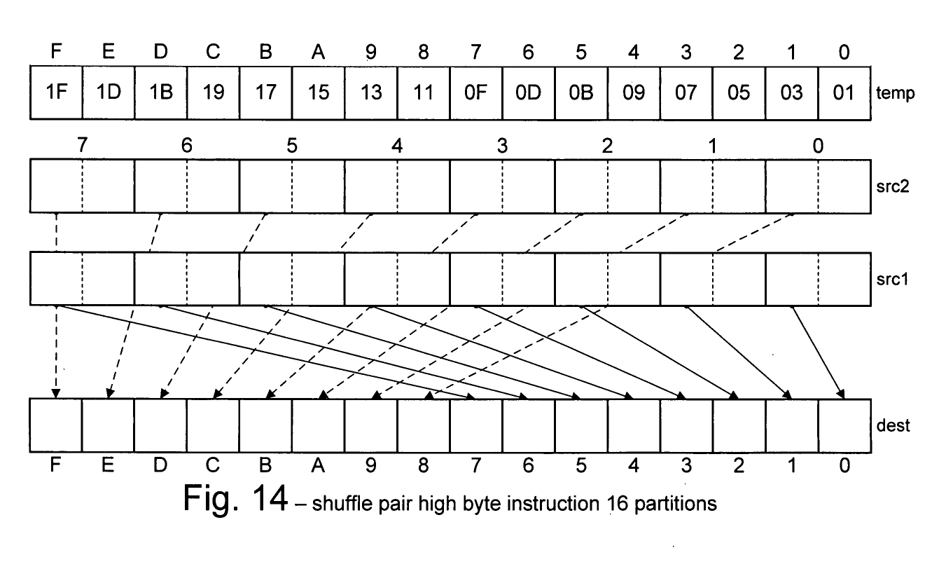

FIG. 13 illustrates the use of the sign-bit replication facility and the byte-wise permute facility in implementing a word-wise unpack sign extended low byte instruction. The instruction specifies a source operand src1 and a destination dest.

Upon encountering this instruction, the processor performs sign bit replication (not shown by arrows) of the sign bits of src1 into temp2, as explained re FIG. 12. It also loads temp with the values shown (which happen to be the same values explained in FIG. 11). It then executes the byte-wise permute operation using src1 and temp2 as the two source operands and temp as the control operand. The end result is that the even-numbered bytes of dest contain the even-numbered bytes of src1, and the odd-numbered bytes of dest contain replicated copies of their associated even-numbered bytes. (Each odd-numbered byte is associated, in word-wise data, with the even-numbered byte immediately below it.)

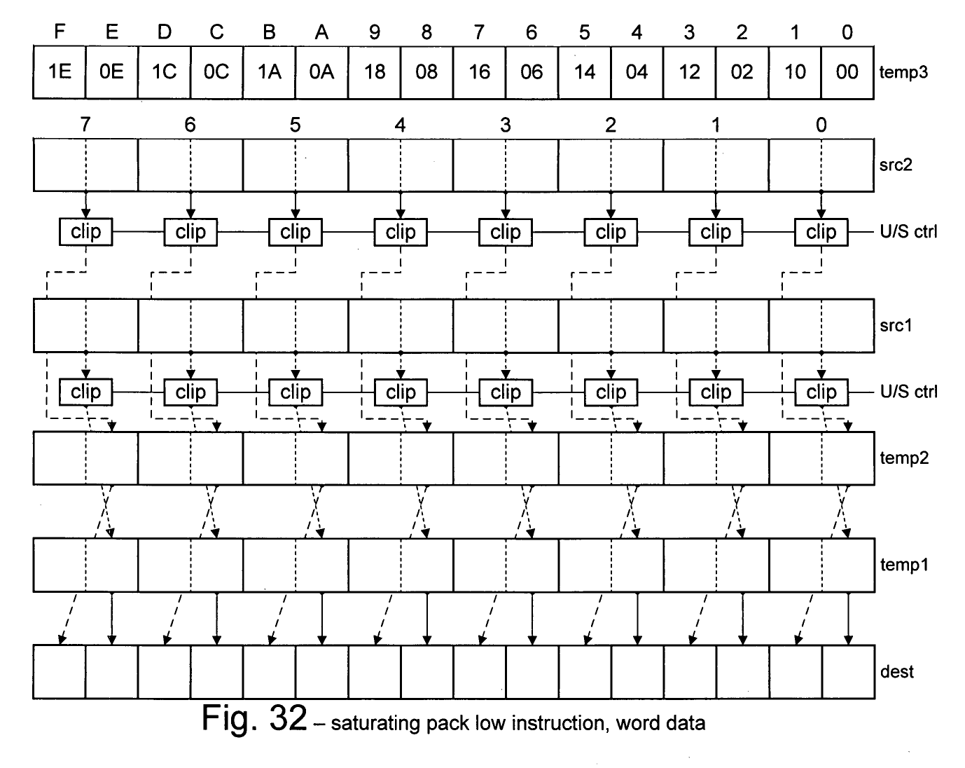

FIG. 32 illustrates one way in which a saturating pack instruction can be implemented using the facilities of this invention. The particular example shown is for a saturating pack low instruction operating upon word data (from which the low bytes are to be extracted and packed). The words of the src1 and src2 operand registers may contain signed or unsigned 16-bit values. In saturating (clipping) arithmetic, when a 16-bit value is cut down to an 8-bit value, the un/signed nature of the sources and destination should be taken into account. The src2 words are fed to respective clipping units which generate the appropriate byte values, under control of signed/unsigned control signals (“U/S ctrl”). The clipped byte results are then written to the low-order bytes of respective words in a temp2 register. Similarly, the src1 words are clipped and written to the low-order bytes of respective words in a temp1 register.

The processor loads the indicated values into the temp3 register, then uses it as the permute control for extracting bytes from the temp2 and temp1 registers and writing the extracted bytes to the dest register.

In the embodiment shown, the instruction performs an “interleaved pack”—the low-order bytes from the two respective sources' words are written to the destination in alternating order, e.g. even-numbered destination bytes come from src1, and odd-numbered destination bytes come from src2. In another embodiment, the instruction performs a “concatenated pack” in which e.g. destination bytes 0 through 7 come from src1, and destination bytes 8 through F come from src2. The difference is simply that in the latter case, the processor will put different permute control values into temp3.

FIG. 14 illustrates the use of the byte-wise permute facility to perform a shuffle pair high byte instruction, with the source operand data in src1 and src2 partitioned into sixteen units; in other words, divided into words. The function of this instruction is to extract the high-order bytes of each word in src1 and copy them sequentially into the low-order half of dest, and to extract the high-order bytes of each word in src2 and copy them sequentially into the high-order half of dest.

The processor implements this functionality by loading the temp control register with the values shown. The pattern of the values is that they count upward from 01 by twos. After the temp register is loaded, the processor can them simply execute the byte-wise permute instruction using temp as the control register.

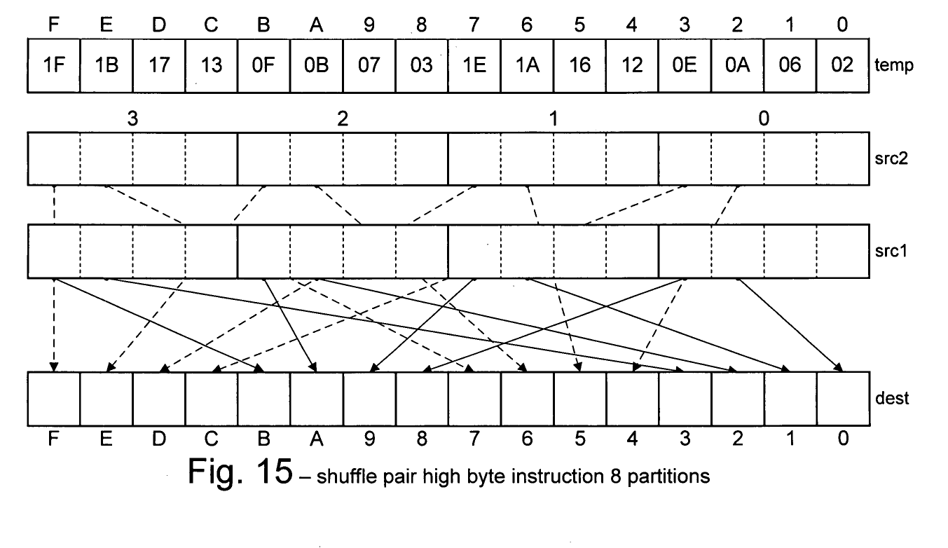

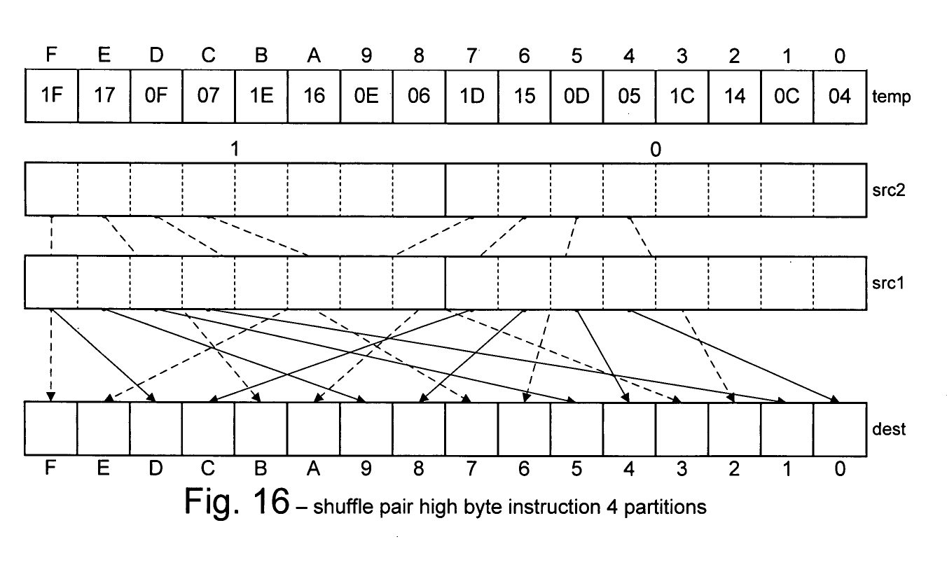

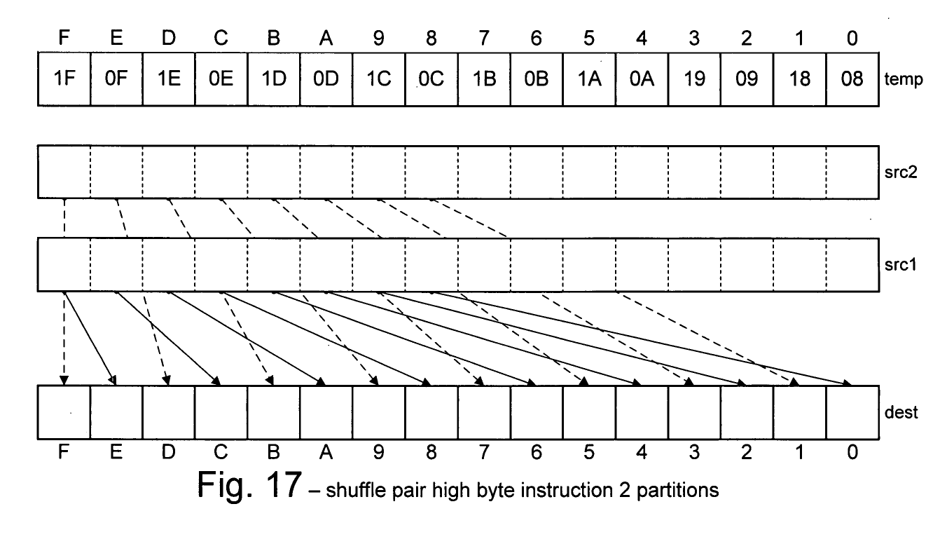

FIG. 15 illustrates the use of the byte-wise permute operation to perform a shuffle pair high byte instruction with the source operand data in src1 and src2 partitioned into eight units; in other words, divided into doublewords. The instruction extracts the high-order two bytes from the doubleword units. The lower of the bytes are copied sequentially into the low-order half of dest, and the higher of the bytes are copied sequentially into the high-order half of dest.

The processor loads the temp control register as shown, then executes the byte-wise permute instruction.

FIG. 16 illustrates the use of the byte-wise permute operation to perform a shuffle pair high byte instruction with the source operand data in src1 and src2 partitioned into four units, or quadwords. The processor loads the temp control register as shown, and executes the byte-wise permute instruction.

FIG. 17 illustrates the use of the byte-wise permute operation to perform a shuffle pair high byte instruction with the source data partitioned into only two units, each occupying one of the source operands src1 or src2. The processor loads the temp control register accordingly, and executes the permute instruction.

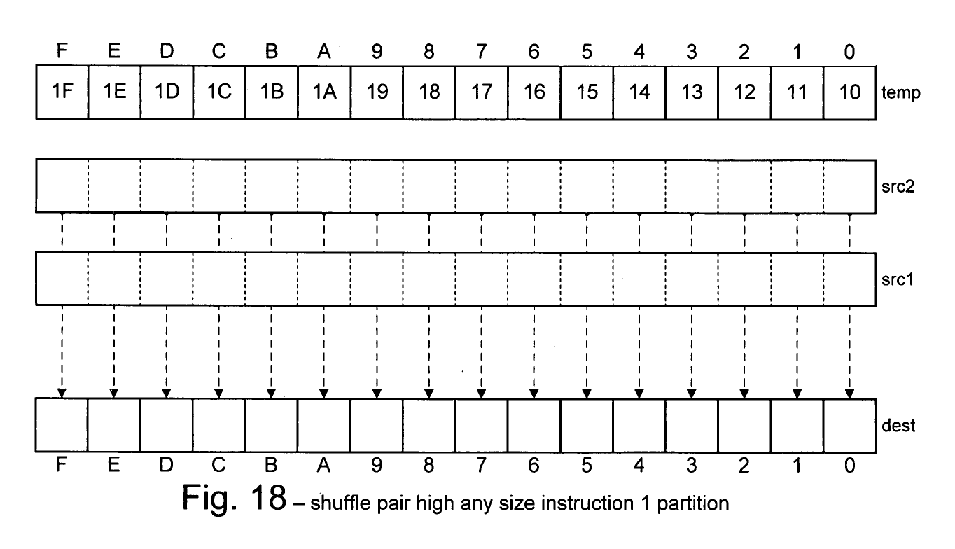

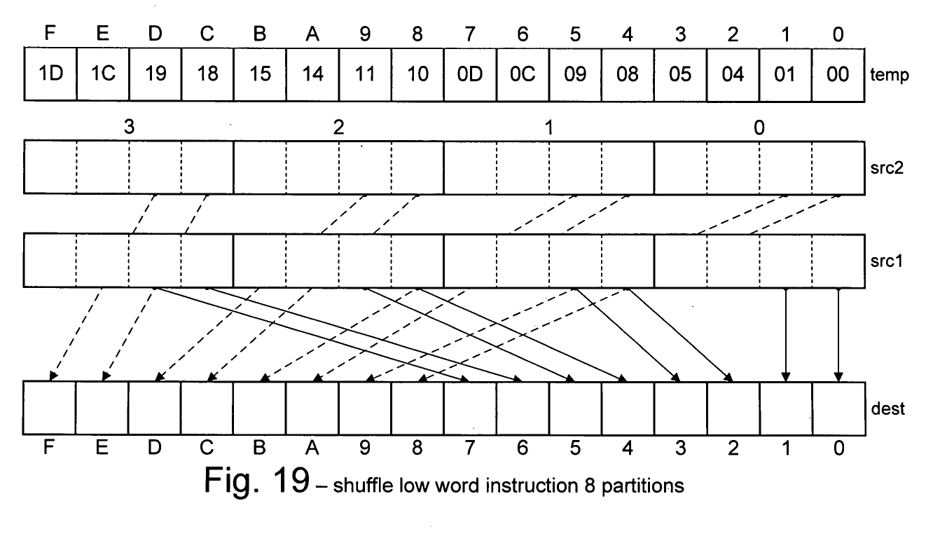

FIG. 18 illustrates the extreme case where the shuffle pair high byte instruction source is not partitioned (or is divided into one single partition). The processor loads the temp control register to cause src2 to be copied straight through to dest, then executes the byte-wise permute instruction.

FIG. 19 illustrates the operation of a shuffle pair low word instruction with the source data partitioned into eight units. The previously describe shuffle pair high byte instruction copied individual bytes from the various partitions, hence the “byte” designation. And it copied them from the high-order half of each partition, hence the “high” designation. It shuffled them into the destination a byte at a time. The shuffle pair low word instruction, by way of contrast, copies words (adjacent, paired bytes) from the low-order half of each partition, and shuffles them into the destination a word at a time.

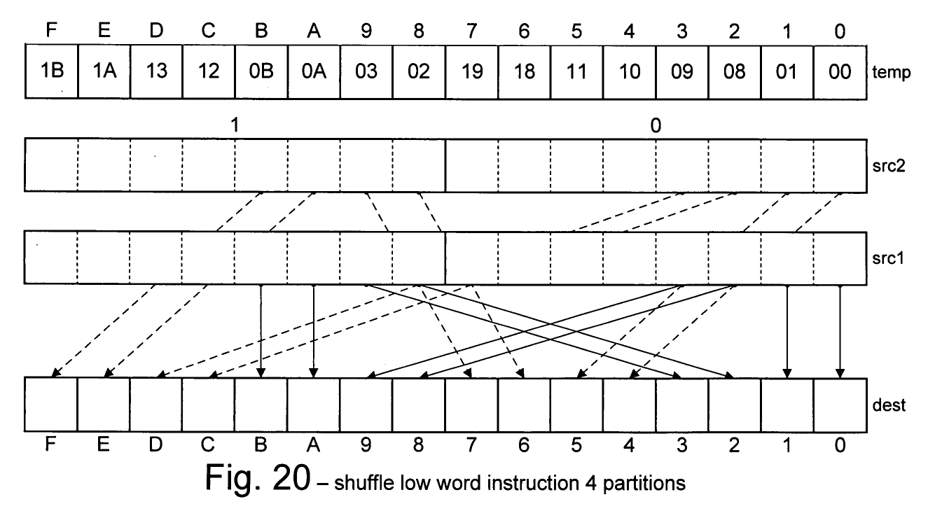

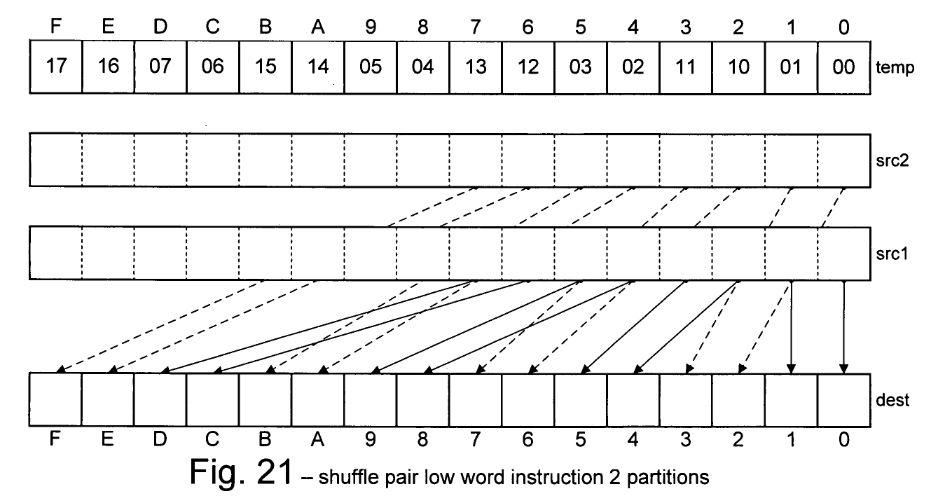

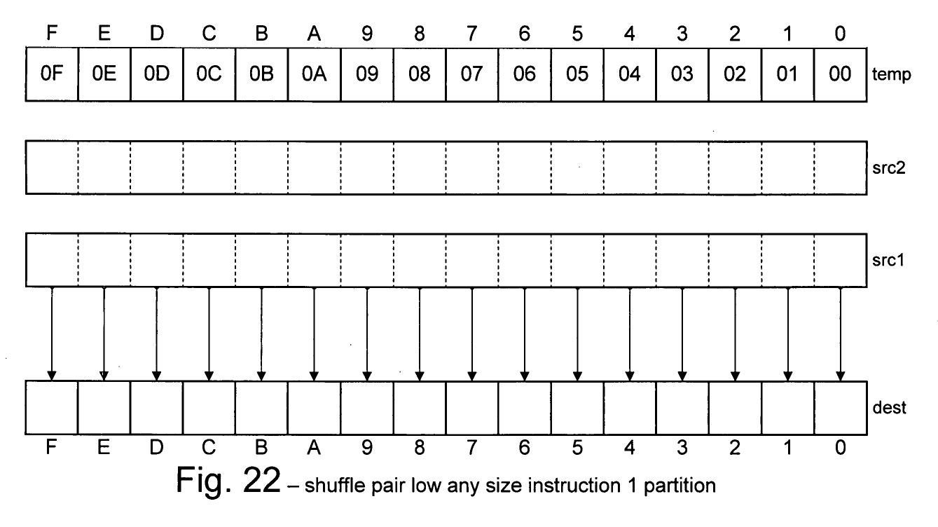

FIGS. 20-22 illustrate the shuffle pair low word instruction operating on data partitioned into four, two, and one partition. It should be noted that the single partition instructions illustrated in FIGS. 18 and 22 are representative of all single-partition shuffles, regardless of element size.

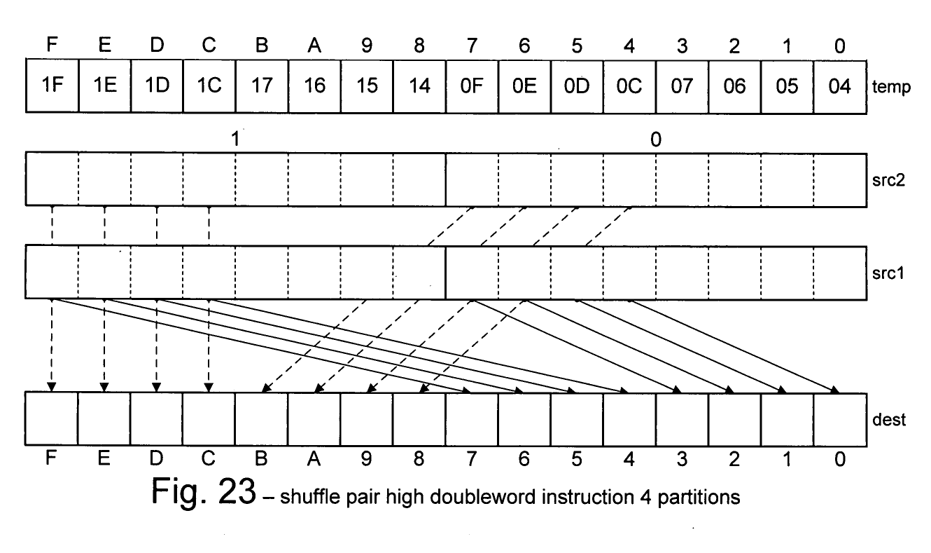

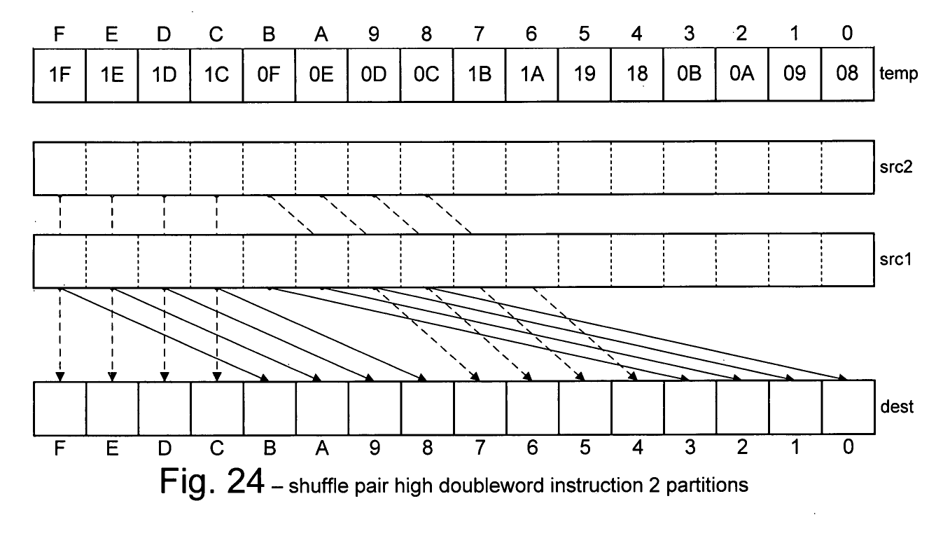

FIGS. 23-24 illustrate a shuffle pair low doubleword instruction with two and four partitions, respectively.

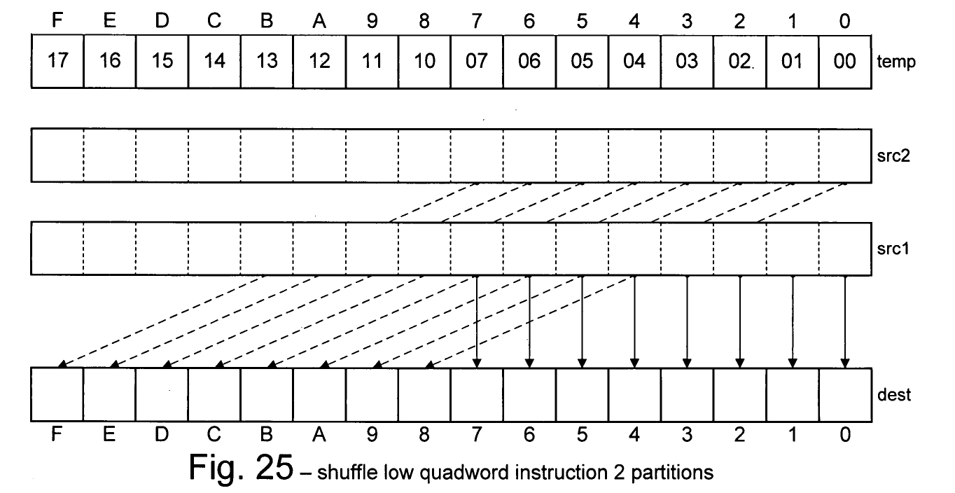

FIG. 25 illustrates a shuffle pair low quadword instruction with two partitions, and is performed in a similar manner as outlined above.

### Bit-Wise Plus Byte-Wise Movement

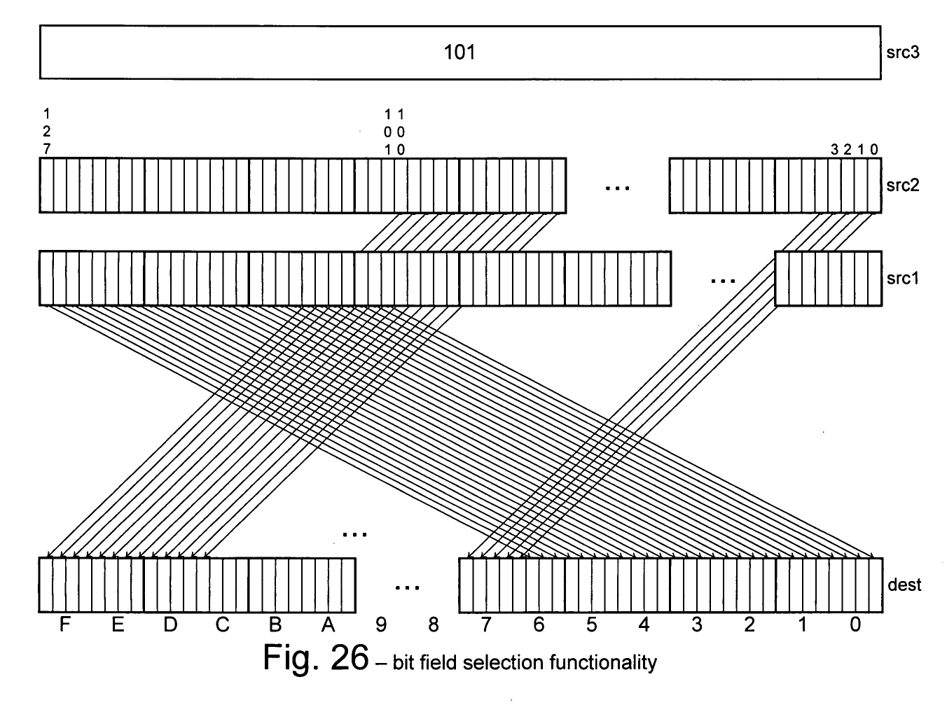

FIG. 26 illustrates the functionality of a bit-wise bit field selection instruction. Its purpose is to shift a pair of source operands left by a number of bit positions specified by a control operand src3, and write the resulting shifted value to dest. In effect, the second source src2 is treated as a high-order octoword and the first source src1 is treated as a low-order octoword, and an octoword is selected from that double-octoword from location {src2,src1}[src3+127:src3]. The other bits of src1 and src2 are not copied to dest. If the instruction specifies the same source as both src1 and src2, the bit field selection instruction has the effect of simply performing a rotation (rather than a shift) on src1.

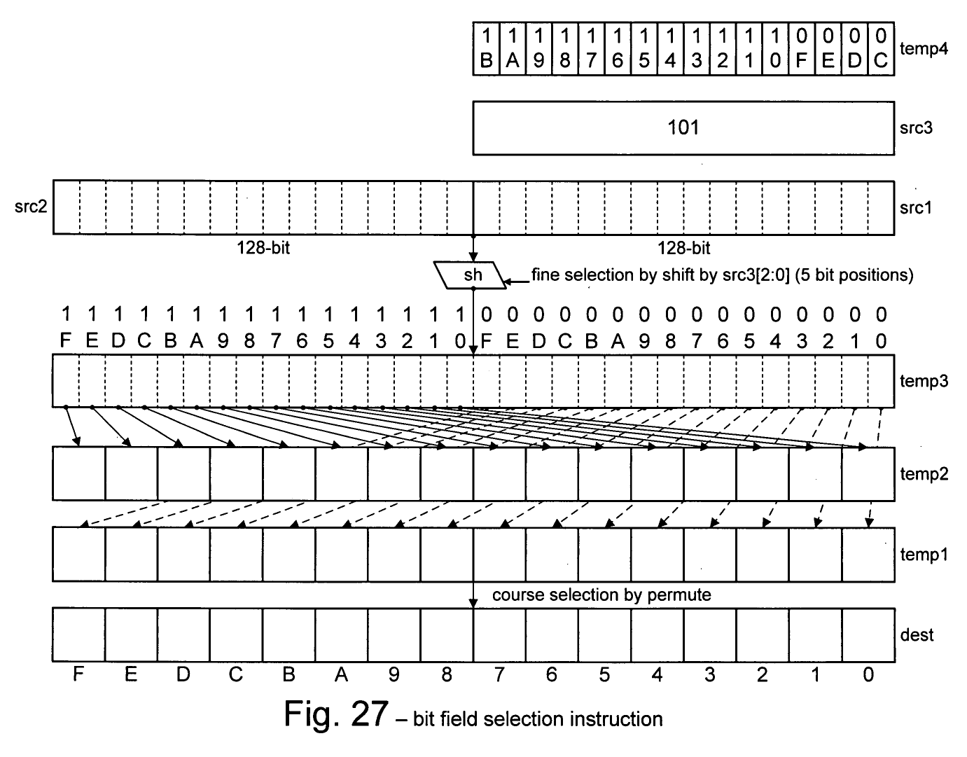

FIG. 27 illustrates one embodiment of how the bit field selection instruction can be implemented using a combination of bit-wise data movement with subsequent byte-wise data movement. The src3 source operand specifies the bit position (shown as a decimal value) from which the processor should extract, using the specified bit position as the least significant bit, a 128-bit value from the 256-bit value which includes src1 as its low-order 128 bits and src2 as its high-order 128 bits.

The processor includes a 256-bit shifter (shown as “sh”) which, for ease of implementation, has been constructed such that it is not necessarily able to perform a full-width shift within the available time (e.g. clock cycle). In the implementation shown, the 256-bit shifter is capable of up to a 7-bit-position shift. The processor uses the low-order three bits src3[2:0] to control the shifter. In the particular case shown, 101 (decimal) in src3 equals 12*8+5, and src3[2:0] will contain the decimal value 5 (with the remaining 96 represented in the higher-order bits of src3).

The processor writes the shifted 256-bit value to 256-bit temporary register temp3, then copies the high-order 16 bytes into temp2 and the low-order 16 bytes into temp1. Alternatively, the shifter output could be written directly into temp2 and temp1 as indicated.

The processor then writes the value src3[7:3], which happens to be 0C in the case of src3=101 decimal, into permute control register location temp4[0], and sequentially higher values into src3[1] through src3[F]. More specifically, it writes the low-order 5 bits of sequentially higher values into those locations, zeroing the high-order 3 bits of the values written; this accommodates wrap-around if the src3 value was greater than 128.

The processor then executes the byte-wise permute operation, writing the results to dest. Thus, the combination of a fine-grain (sub-byte) shift is used to get the operand data into a configuration in which a course-grain (byte-wise) permute can be used to effect a shift that is significantly greater (in terms of the shift count) than the shifter can itself perform. This enables the shifter to be significantly simplified and sped up and its area and power consumption reduced.

Rotate instructions can be similarly implemented.

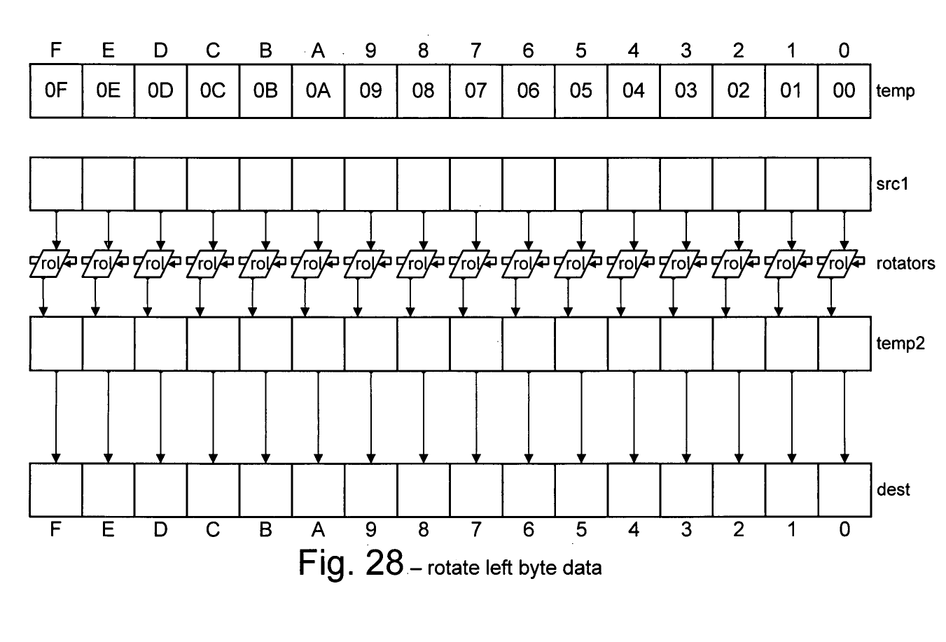

FIG. 28 illustrates how the processor may be constructed to execute a rotate left instruction with byte data granularity. The instruction specifies a source operand src1 and a destination dest. The processor includes sixteen rotators, each in the data path of a respective byte of the byte permutation execution unit.

Upon encountering the rotate left byte data instruction, the processor loads the temporary control register temp with the sequential values as shown. Each value is simply the number of its byte position within the register. The processor then executes the byte data left rotate by passing each src1[i] byte to its corresponding rotator, and the result from each rotator is written to a respective, corresponding byte of a temporary destination register temp2. The processor then executes the byte-wise permute operation using temp as the control, temp2 as the source, and dest as the destination. With the sequential values in temp, no byte-wise movement is caused.

In one embodiment, the one 256-bit-wide shifter of FIG. 27 and the sixteen 8-bit-wide rotators of FIG. 28 can be constructed using the same components. This is true of other width configurations shown elsewhere in this disclosure, as well.

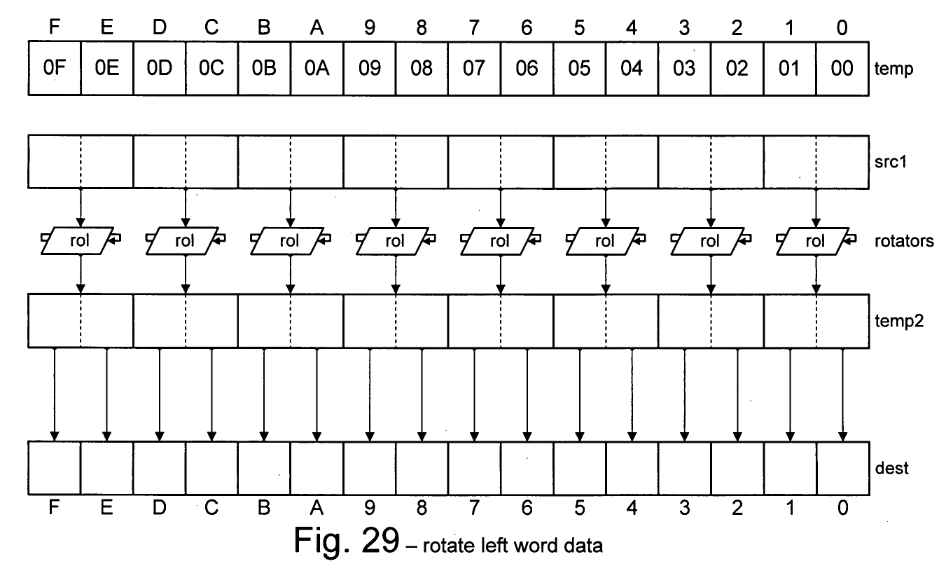

FIG. 29 illustrates a similar operation performed for a rotate left instruction specifying word data. Each two-byte position in the data path includes a 16-bit rotator. The processor uses the same sequential temp values as in FIG. 28. After the 16-bit rotated values have been written to temp2, the byte-wise permute operation copies them to dest.

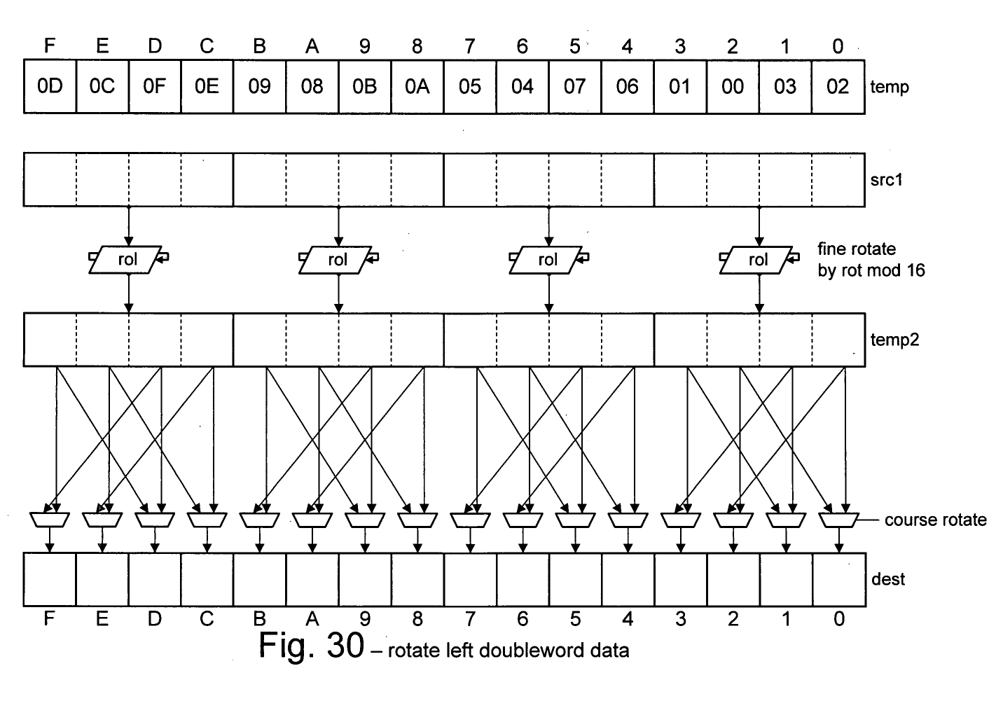

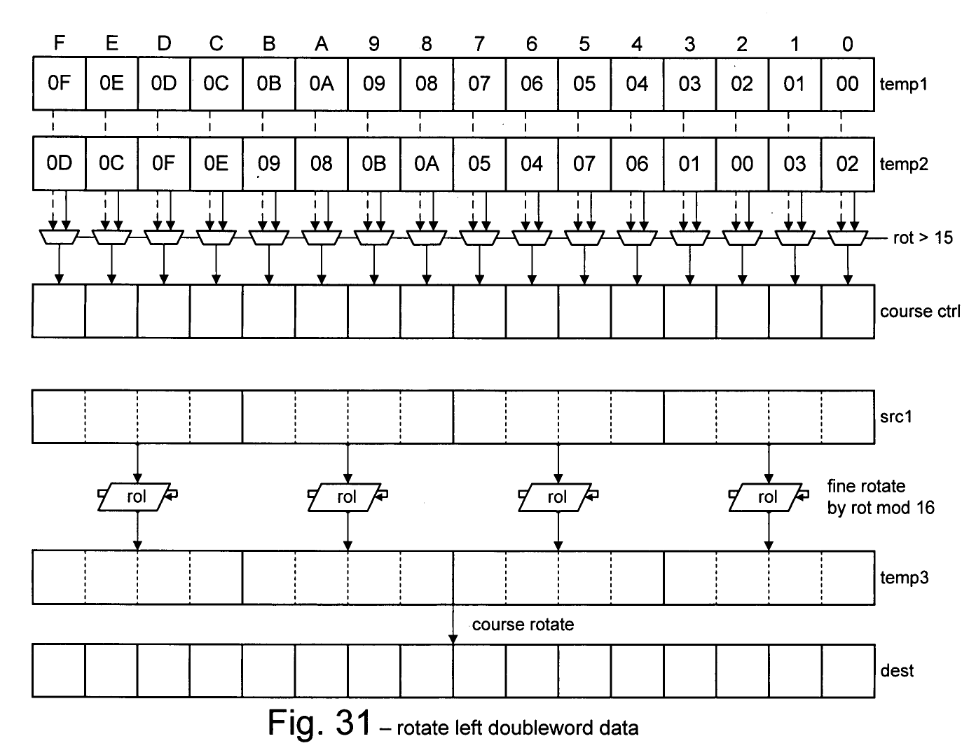

FIG. 30 again introduces the concept that having the byte-wise permute capability can be used to simplify the processor's bit-wise data movement facilities, without losing any overall data movement capability.

Assume that the instruction set architecture (ISA) of the processor mandates that the processor be able to execute up to 32-bit rotates on doubleword (32-bit) data elements. In one implementation, not using this invention, the processor could be provided with four 32-bit rotators each capable of rotating any number of bit positions between 0 and 32. Such a rotator is somewhat complex and its design may limit the maximum clock speed of the processor.

More advantageously, the processor can be constructed to utilize the present invention's byte-wise permute operation in combination with a less capable, simplified rotator. For example, as illustrated, each rotator may be capable of no more than 16-bit rotation.

The processor loads the temporary control register temp with the values shown, and provides each doubleword value from src1 to its respective rotator. The rotator is 32 bits wide, but is capable of only 16 bit positions' rotation at a time. The processor takes the rotate count supplied by the instruction, and provides it modulo 16 (by sending only the low-order four bits) to each of the rotators. The outputs of the rotators are written to respective doublewords in temp2. This is a “fine grain rotate” operation.

The processor then performs a “course grain rotate” operation to complete the rotate instruction. In one implementation, the processor may include a set of multiplexers each wired to receive values from two byte positions in temp2, as shown; one is a straight pass-through, and one is two bytes removed within the doubleword. The processor can then use the fifth bit position of the rotate count specified by the instruction, to control which of these two values is muxed through to the corresponding byte position in dest. The fifth bit position is the “16's value”, and is 1 if the shift count is between 16 and 31.

Alternatively, the processor can use this fifth bit position in determining whether to load temp with the values shown, or with sequential “00 01 02 . . . 0F” (from lsb to msb, right to left) values. Then, after the fine-grain rotate, the processor can simply invoke the byte-wise permute operation. In this implementation, the course rotate multiplexers are not needed and can be omitted from the machine.

FIG. 31 illustrates the execution of a rotate left instruction upon doubleword data in that manner. Upon detecting the rotate left opcode, the processor loads a first control register temp1 with sequential pass-through values, and loads a second control register temp2 with the “rotate two byte positions” values shown. Then, depending on whether the rotate count is greater than 15, one of those two control data sets is muxed into a course rotate control register. Alternatively, the course control register could be loaded directly e.g. by microcode, rather than creating two sets and throwing one away.

The src1 data are fine grain rotated by the 32-bit rotators, using the rotate count modulo 16, and the results are written to an intermediate destination register temp3. The processor then invokes the permute operation using temp3 as the source and course ctrl as the control, and writes the results to dest.

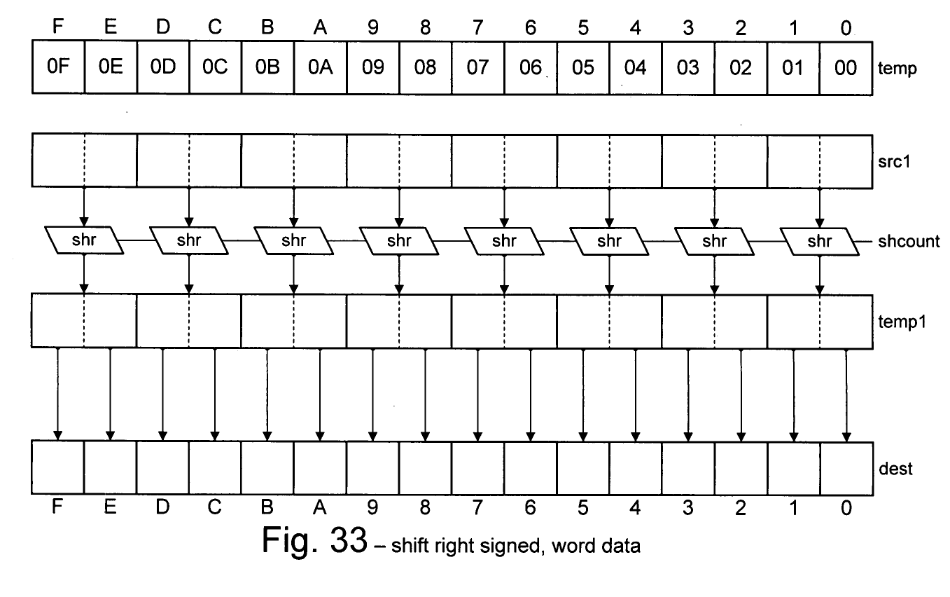

FIG. 33 illustrates one way in which a shift right signed data instruction can be implemented. In this instance, the processor has eight shifters (“shr”), each of which is capable of shifting its data up to 16 bit positions according to a 4-bit shcount shift count control input. The instruction specifies the source operand src1, the shift count, and the destination dest. The processor loads the temp register with the pass-through permute control values shown, and the processor executes the permute operation on temp1 to write the shifted results to the dest register.

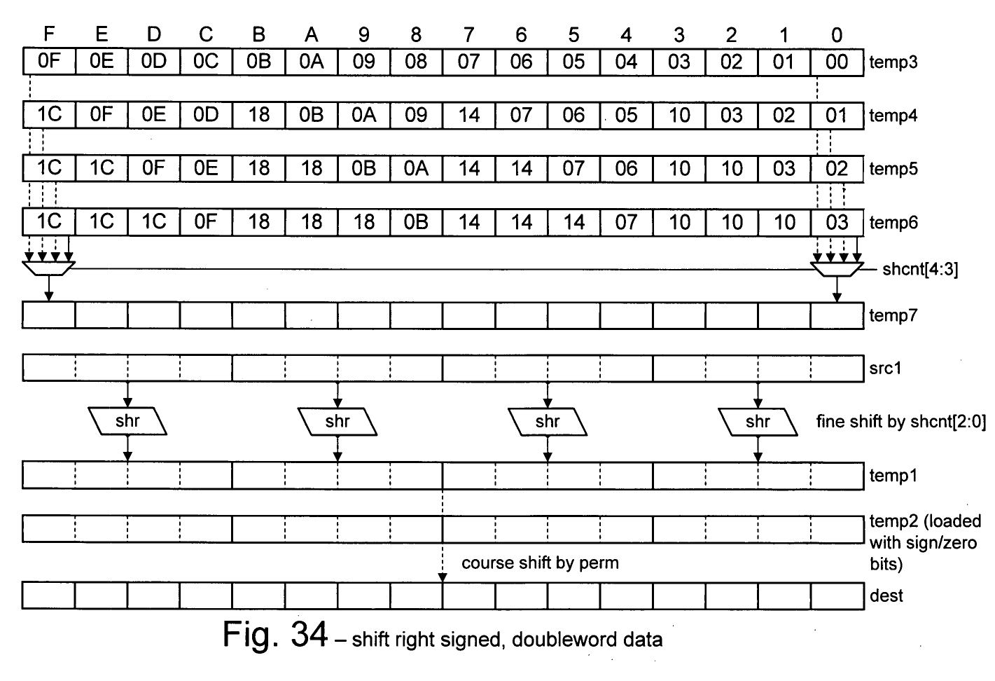

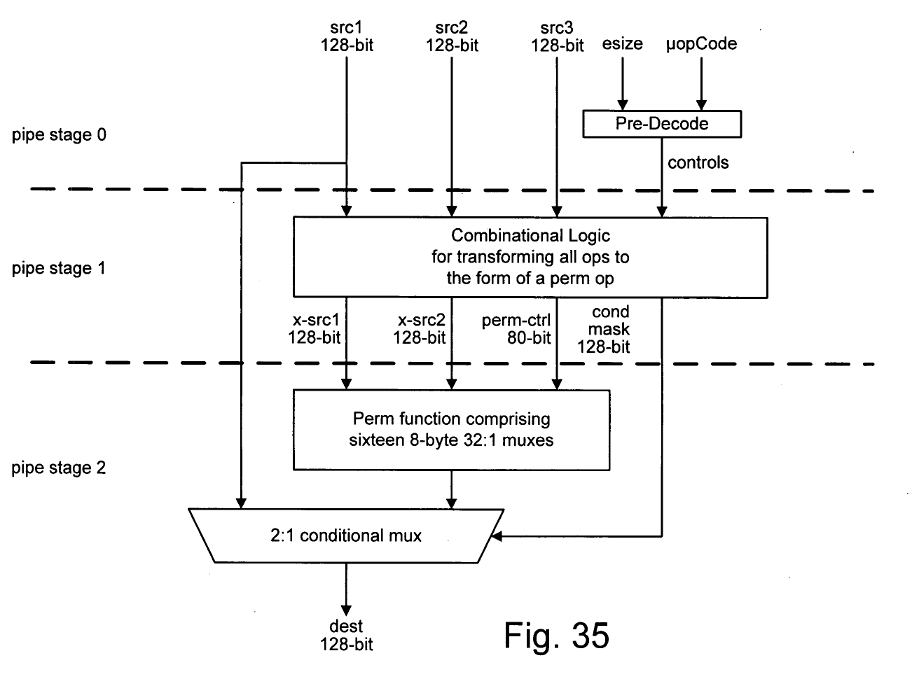

FIG. 34 illustrates the more complicated scenario where the shift instruction specifies a II shift count that is greater than the shift capabilities of the shifters. In the example given, four 32-bit shifters are capable of up to a 7-bit shift each, and the instruction can specify up to a 31-bit shift. The processor loads temp3 through temp6 with permute control values which shift by zero, one, two, and three byte positions, respectively. Then, the course permute control values are selected (into a register, as shown, or for direct use e.g. on wires) from those values by muxes according to shift count bits shcount[4:3]. The operand data in src1 are “fine grain” shifted by shcnt[2:0] bit positions, and the intermediate results are written to temp7. If the instruction specifies signed data, then the sign bits of the respective doublewords are copied into the low-order bytes of the corresponding doublewords of temp2. If the instruction specifies unsigned data, then those low-order bytes are populated with zeroes. The processor then uses the course grain permute to complete the shift.

FIG. 35 illustrates one embodiment of a data path pipeline which can be used in implementing this invention. In a first pipe stage, the instruction is pre-decoded to generate a set of control values based upon the operation code (μopCode) and element size (eSize) indicated in the instruction. In a second pipe stage, those control values are used to control the operation of combinational logic which receives any src1, src2, and src3 values from the instruction's operand fields and transforms them (e.g. by performing fine-grain data manipulation) to put them into a suitable form (e.g. byte-aligned) for a subsequent course-grain perm operation. In a third pipe stage, the perm operation is performed on the transformed src1 and src2 values (xsrc1 and xsrc2, respectively) in accordance with a set of generated permute control values. If the machine is equipped to handle conditional instructions, the second pipe stage's combinational logic also generates a conditional mask, which is used in the third pipe stage to select between the original src1 value and the output of the perm function. The result is written to the destination, and is typically also sent to a slot mux and to a bypass network for early availability as a source operand in other instructions.

### CONCLUSION

It is not necessary to provide the user with an exhaustive list detailing every possible way that the flexible permute operation can be used to perform other, more rigid data movement operations. Nor is it necessary to provide the user with an exhaustive list detailing every possible way in which bit-wise data manipulations can be combined with the flexible permute operation to perform bit-wise data movements in the absence of complex, dedicated hardware. After reading this disclosure and studying the examples given in the various drawings, the reader will appreciate these principles and understand how to apply them to any data movement operation that happens to be required in his application at hand. The invention has been discussed in terms of various implementations in which the smallest “course grain” data element is the 8-bit byte, but the invention is not so limited; in other implementations, the smallest course grain data element might be, for example, a 12-bit pixel value, or a 16-bit floating point value, or what have you. The smallest course grain data element can, regardless of its size, be referred to as a “base element” or an element having a “base size”. Rotates, shifts, shuffles, merges, explodes, rotates, shifts, permutes, and the like may collectively be termed “data rearrangement instructions”. Registers, memory locations, latches, gates, and the like may collectively be termed “data storage locations”.

The invention has been described with reference to its use in implementing a machine adapted for performing instructions such as rotate, shift, permute, pack, unpack, bit field selection, merge, expand, and so forth. It may also be used in performing other instructions, such as move, insert, and so forth. The invention may be used in a processor of any type of architecture, whether RISC, CISC, VLIW, or what have you. It may be used in processors that are microcoded, as well as those which are not. It may be used in processors which are primarily designed for digital signal processing, as well as those adapted for more general purpose use. It may be used in any particular type of system, such as embedded control systems, cell phones, personal digital assistants, computers, consumer electronic devices, automotive systems, and so forth. It may be used in a processor which is adapted to execute instructions from exactly one single ISA, or in a processor which is adapted to execute instructions from two or more ISAs.

When one component is said to be adjacent another component, it should not be interpreted to mean that there is absolutely nothing between the two components, only that they are in the order indicated. The various features illustrated in the figures may be combined in many ways, and should not be interpreted as though limited to the specific embodiments in which they were explained and shown. Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A processor comprising:
an instruction decoder for decoding ISA instructions;
a plurality of execution units, including a permute facility;
means responsive to the decoding of a data rearrangement instruction which is not an ISA permute instruction, for loading a control storage element with a plurality of permute control values; and
means responsive to the decoding of the data rearrangement instruction, for
performing fine-grain manipulation of operand data specified by the instruction, and then
invoking the permute facility to complete course-grain manipulation of the operand data according to the permute control values loaded in the control storage element,
whereby the processor is capable of executing data rearrangement instructions which include fine-grain data rearrangement, using a reduced-capability fine-grain data manipulation facility, by using the course-grain permute facility to augment the reduced-capability fine-grain data manipulation facility.

2. The processor of claim 1 wherein the fine-grain data manipulation facility comprises a rotator.

3. The processor of claim 1 wherein the fine-grain data manipulation facility comprises a shifter.

4. The processor of claim 1 wherein the data rearrangement instruction comprises a bit-field selection instruction.

5. The processor of claim 1 wherein the data rearrangement instruction comprises a rotate instruction.

6. The processor of claim 1 wherein the data rearrangement instruction comprises a shift instruction.

7. A method whereby a processor executes ISA instructions including a data manipulation instruction specifying data manipulations smaller than a basic data element size of the processor, the method comprising:
using a fine-grain data manipulation facility of the processor to partially perform a functionality of the data manipulation instruction and align intermediate result data on basic data element size boundaries; and then
using a course-grain permute facility of the processor to rearrange basic data elements of the intermediate result data, to generate final result data.

8. The method of claim 7 further comprising:
in response to an opcode of the data manipulation instruction, retrieving permute control values from a table; and
the course-grain permute facility rearranging the basic data elements in accordance with the retrieved permute control values.

9. The method of claim 7 further comprising:
in response to a subset of bits of an operand of the data manipulation instruction, retrieving permute control values from a table; and
the course-grain permute facility rearranging the basic data elements in accordance with the retrieved permute control values.

10. The method of claim 7 further comprising:
in response to an opcode of the data manipulation instruction, calculating permute control values; and
the course-grain permute facility rearranging the basic data elements in accordance with the calculated permute control values.

11. The method of claim 7 further comprising:
in response to a subset of bits of an operand of the data manipulation instruction, calculating permute control values; and
the course-grain permute facility rearranging the basic data elements in accordance with the calculated permute control values.

12. The method of claim 7 wherein using the fine-grain data manipulation facility comprises operating a rotator.

13. The method of claim 7 wherein using the fine-grain data manipulation facility comprises operating a shifter.

14. The method of claim 7 wherein the data rearrangement instruction comprises a bit-field selection instruction.

15. The method of claim 7 wherein the data rearrangement instruction comprises a rotate instruction.

16. The method of claim 7 wherein the data rearrangement instruction comprises a shift instruction.

17. An improvement in a processor having a plurality of execution units including a permute unit adapted to perform course-grain data rearrangement and a rotator adapted to perform fine-grain data rearrangement, the improvement comprising:
the processor being adapted to use the rotator to partially perform a data manipulation instruction sufficiently to align intermediate result data to basic data element boundaries; and
the processor being adapted to then use the permute unit in a configurable manner to perform course-grain data rearrangement of the intermediate result data to generate final result data;
whereby the processor is capable of executing a fine-grain data manipulation instruction which specifies fine-grain data manipulation exceeding an ability of the rotator.

18. The improvement of claim 17 in the processor, the improvement further comprising:
a table storing a plurality of sets of course-grain permute control values; and
means for retrieving a set of course-grain permute control values from the table in response to use of the permute unit in generating the intermediate result data.

19. The improvement of claim 17 in the processor, the improvement further comprising:
logic for generating course-grain permute control values for controlling operation of the permute unit, in response to use of the permute unit in generating the intermediate result data.

20. The improvement of claim 17 in the processor, wherein the data manipulation instruction comprises a bit-field selection instruction.

21. The improvement of claim 17 in the processor, wherein the data manipulation instruction comprises a rotate instruction.

22. The improvement of claim 17 in the processor, wherein the data manipulation instruction comprises a shift instruction.
